(19) United States
(12) Patent Application Publication
(10) Pub. No.: US 2014/0098450 A1
(43) Pub. Date: Apr. 10, 2014

(54) PROTECTION RELAY SYSTEM AGAINST SINGLE-PHASE FAULTS FOR MEDIUM-VOLTAGE DISTRIBUTION NETWORKS

(71) Applicants: Electricite de France, Paris (FR); SCHNEIDER ELECTRIC INDUSTRIES SAS, Rueil Malmaison (FR)

(72) Inventors: Cristian JECU, Grenoble (FR); Philippe Alibert, Lans en Vercors (FR); Bertrand Raison, Saint-Martin-d'Heres (FR); Olivier Chilard, Fontenay-Aux-Roses (FR)

(73) Assignees: Electricite de France, Paris (FR); SCHNEIDER ELECTRIC INDUSTRIES SAS, Rueil Malmaison (FR)

(21) Appl. No.: 14/046,215

(22) Filed: Oct. 4, 2013

(30) Foreign Application Priority Data
Oct. 5, 2012 (FR) 12 02678

(51) Int. Cl. H02H 3/40

(52) U.S. Cl. CPC H02H 3/40
USPC 361/83

(57) ABSTRACT

The electrical power distribution network comprises a medium-voltage feeder having an upstream end intended to be connected to a power source. The feeder includes at least first and second consecutive protection relays positioned along the feeder and defining the ends of a first element to be monitored. The first protection relay includes a search module configured to trip a breaker to interrupt the electrical power distribution:
after a first time delay when the search module detects a single-phase permanent fault in a monitoring area of the first element; and
after a second time delay longer than the first time delay when the search module detects a single-phase permanent fault in an additional monitoring area located downstream of the area.

### BACKGROUND OF THE INVENTION

The invention relates to an electrical power distribution network comprising a medium-voltage feeder having an upstream end and a downstream end, the upstream end being intended to be connected to a power source.

### STATE OF THE ART

The delivery of electrical power, from production centers to the customers, is organized in two main levels. The first level corresponds to a high-voltage transmission network (HV) usually for a phase-phase voltage greater than 50 kV. The high-voltage transmission network is intended to transmit the electrical power from production centers and power plants to distribution centers which serve power consumption areas. The second level corresponds to a medium-voltage distribution network (MV) usually for a phase-phase voltage lower than 50 kV. The medium-voltage distribution network enables to locally transport electrical power from the distribution centers to the final customer.

Current electrical power distribution networks keep on developing. As an example, the development and the incentive regulations for renewable energies have promoted a considerable increase of the connection rate of dispersed energy generation (DG) devices. Thus, a protection relay system associated with a current medium-voltage electric network should adapt to such an evolution to improve the quality of the power supply and connection service. Distributors first attempt to keep a maximum number of consumers and, by a certain extent, a maximum number of local producers, connected, in case a fault should occur in the system. Thereby, power distribution networks are preferably divided into areas protected by protection relays deployed along the network.

Generally, a protection relay is used to detect insulation faults capable of occurring in an electric network. The protection relay function is achieved by multifunction modules which continuously compare the electric quantities of the network to thresholds. According to the protection relay type, the multifunction modules may measure a current, a voltage, or also a frequency, and calculate from these measured quantities other quantities, and especially powers and impedances. A protection relay detects a fault when a measured or calculated quantity has an abnormal value. Thus, the multifunction module gives action orders, such as the order to open a circuit breaker.

The efficiency of a system for protecting an electrical power distribution network strongly depends on the selectivity of the protection relays deployed in a network. Selectivity means the way to adjust protection relays to enable them to act properly, in a coordinated manner, and as fast as possible. The selectivity imposes accurate adjustments which enable protection relays to isolate the system area comprising a fault while leaving the other healthy zones of the system powered on, if possible. According to the configuration of the power distribution network, and according to the means available for the network designer, different selectivities may be implemented.

As an example, differential and logic selectivities may be used in a system of protection relay of a medium-voltage distribution network. However, such selectivities require a fast communication between protection relays for an efficient use in a system of protection relays deployed in series. The communication between protection relays implies using additional connection wires, and thus a higher cost and an additional risk of failure. Generally, to have several protection relays operate in series, the protection relays use a chronometric selectivity. The protection relays deployed in a feeder connected to a HV/MV substation, are adjusted with a decreasing time delay from the HV/MV substation to the end of the feeder opposite to said HV/MV substation. Thus, respecting time delay limits and the need to have back-up protection relays, the number of protection relays which can be deployed is limited and generally does not exceed three protection relays.

A time-space selectivity may also be used in an electric network comprising several protection relays arranged in series. This type of selectivity relies on the discrimination by a given protection relay, of a fault occurrence area. When the network is not homogeneous, determining the location where a fault occurs, or even of a fault occurrence area, becomes difficult, which limits the use of this selectivity type in medium-voltage networks. Nowadays, medium-voltage distribution networks are increasingly complex. Indeed, most of these networks are heterogeneous networks which may comprise dispersed generation devices (DG). Determining a fault occurrence area in this type of network then becomes a complicated task.

### SUMMARY OF THE INVENTION

The invention aims at providing a protection relay system for a medium-voltage electrical distribution network, comprising several protection relays in series, which is easy to implement and capable of adapting to different configurations of the distribution networks, and especially those comprising heterogeneous conductors.

This object tends to be achieved by providing an electrical power distribution network comprising a medium-voltage feeder having an upstream end and a downstream end, the upstream end being intended to be connected to a power source, and at least first and second consecutive protection relays positioned along said feeder and arranged so that the first protection relay is located between the upstream end of the feeder and the second protection relay, the first and the second protection relays defining the upstream and downstream ends of a first element associated with the first protection relay.

Further, the first protection relay comprises a breaker circuit for cutting out the electrical power distribution downstream of the first protection relay, and a search module configured to detect a single-phase permanent fault downstream of the first protection relay, the search module being provided with a phase current and phase voltage measurement circuit.

The first protection relay also comprises a system for calculating a complex quantity Zᵢ having a real part Re(Zᵢ) and an imaginary part Im(Zᵢ), from the measured phase voltage and phase current, and a circuit for comparing calculated complex quantity Zᵢ with first and second complex thresholds corresponding to first and second straight lines in a complex plane associated with reference frame (O, Re(Zᵢ), Im(Zᵢ)).

The first complex threshold defines in the complex plane a first domain configured to represent the occurrence of a single-phase permanent fault in a monitoring area comprised in the first element and having the first protection relay as an upstream end. The first and second thresholds also define in the complex plane a second domain which does not overlap with the first domain, and which is configured to represent the occurrence of a single-phase permanent fault in an additional monitoring area distinct from the monitoring area and arranged downstream thereof so that the downstream end of the monitoring area corresponds to the upstream end of the additional monitoring area.

Further, the breaker is configured to cut out the electrical power distribution after:
a first time delay when calculated complex quantity Zᵢ belongs to the first domain of the complex plane;
a second time delay longer than the first time delay when calculated complex quantity Zᵢ belongs to the second breaker of the complex plane, and when the single-phase fault is still detected after the first time delay.

A method for protecting the electrical power distribution network comprising the following steps on detection of a single-phase permanent fault by the first protection relay is also provided:
a calculation of complex quantity Zᵢ from a phase voltage and phase current measured by the measurement circuit;
a comparison of calculated value Zᵢ with the first and second complex thresholds corresponding to straight lines in complex reference frame (O, Re(Zᵢ), Im(Zᵢ));
a verification of the presence of a single-phase permanent fault either in the monitoring area, or in the additional monitoring area.

### BRIEF DESCRIPTION OF THE DRAWINGS

The foregoing and other features and advantages of the present invention will be discussed in detail in the following non-limiting description of specific embodiments in connection with the accompanying drawings, among which:

FIG. 1 schematically illustrates an electrical power distribution network comprising several protection relays arranged in series according to a specific embodiment of the invention;

FIG. 2 schematically illustrates the theoretical representation in a complex reference frame of two domains of the complex plane, defined by two complex thresholds associated with two areas to be monitored by a protection relay arranged in the network of FIG. 1;

FIGS. 3 to 5 schematically illustrate examples of a network or of portions of electrical power distribution networks comprising three protection relays in series according to embodiments of the invention;

FIG. 6 schematically illustrates a theoretical electrical power distribution network for study purposes comprising three protection relays in series;

FIG. 7 schematically illustrates the representation in a complex reference frame of the values, obtained by simulation, of a complex quantity associated with a protection relay arranged in the theoretical study system of FIG. 6;

FIG. 8 schematically illustrates the representation in a complex reference frame of the values of a complex quantity associated with a protection relay arranged in a theoretical study system, obtained by simulation; and

FIG. 9 shows steps of a method for modulating a calculation coefficient for the determination of complex thresholds associated with a protection relay arranged in the network of FIG. 1.

### DESCRIPTION OF PREFERRED EMBODIMENTS

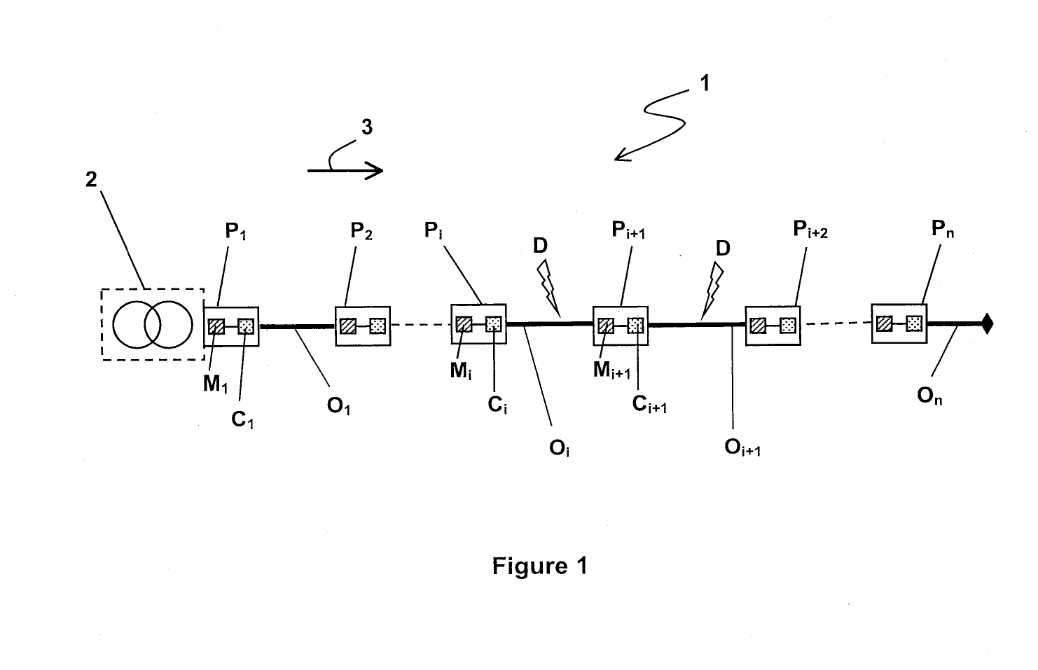

According to an embodiment of the invention illustrated in FIG. 1, an electrical power distribution network comprises a medium-voltage feeder 1 having an upstream end and a downstream end. The upstream end is intended to be connected to a power supply source 2, thus allowing electrical power distribution along a distribution direction 3. Power source 2 may be formed of a high voltage to medium voltage substation (HV/MV). HV/MV substation means the interface between a high voltage transmission network and a medium-voltage distribution network. A HV/MV substation also comprises HV/MV transformers, incoming feeders, a busbar, and outgoing feeders.

The system also comprises at least two protection relays deployed in feeder 1. In the following description, and to simplify the notation of the different protection relays deployed in feeder 1, it will be considered that the protection relays form a series of n protection relays, n being an integer greater than or equal to 2, and that each protection relay Pⱼ of this series will be associated with a rank j, j being an integer ranging between 1 and n. Protection relays Pⱼ are positioned in feeder 1 from the upstream end to the downstream end of feeder 1 according to an increasing rank j.

As illustrated in FIG. 1, the system comprises at least first and second consecutive protection relays Pᵢ and Pᵢ₊₁, positioned along said feeder 1, and arranged so that first protection relay Pᵢ is arranged between the upstream end of feeder 1, along distribution direction 3, and second protection relay Pᵢ₊₁. First and second protection relays Pᵢ and Pᵢ₊₁ define the upstream and downstream ends, along distribution direction 3, of a first element Oᵢ. Here, element is a section of feeder 1 delimited by two breakers and capable of comprising heterogeneous conductors, for example, overhead lines and underground cables. Element Oᵢ, is associated with first protection relay Pᵢ. Further the system comprises a second element Oᵢ₊₁ associated with second protection relay Pᵢ₊₁ which defines its upstream end.

First protection relay Pᵢ comprises a search module Mᵢ, usually called protection relay relay, and a breaker Cᵢ configured to interrupt the electrical power distribution, downstream of first protection relay Pᵢ. Breaker Cᵢ is controlled by search module Mᵢ which is provided with a phase current and phase voltage measurement circuit. Search module Mᵢ is configured to detect a single-phase permanent fault D appearing downstream of first protection relay P and to determine the current directionality of this fault and the faulted phase. Search module Mᵢ also has the function of discriminating an area of the feeder located downstream of first protection relay Pᵢ comprising single-phase permanent fault D.

For a power source 2 formed of a compensated neutral grounded HV/MV substation, the detection of faults by search module Mᵢ in feeder 1 is preferentially carried out based on the criterion used by a protection relay of PWH type (PWH standing for French phrase “protection wattmétrique homopolaire”, that is, zero-sequence wattmetric protection relay). Actually, PWH-type protection relays use the active component of the zero-sequence power. For the other connections to ground, search module Mᵢ may use a directional current criterion using the zero-sequence current. Such a detection is associated with a principle of detection of the faulted phase which enables to apply a discrimination algorithm on the faulted phase only.

First protection relay Pᵢ operates according to a time-space selectivity. In other words, in order to detect of a single-phase permanent fault D appearing in feeder 1 and downstream of first protection relay Pᵢ search module Mᵢ determines an area of variable size of occurrence of fault D in feeder 1. According to the position of the area of occurrence of fault D in feeder 1, search module Mᵢ decides either to continue or to cut out the electrical power distribution downstream of first protection relay Pᵢ. To cut out the electrical power distribution, search module Mᵢ gives to breaker Cᵢ the order of tripping after a previously-determined time delay. The value of the time delay for the tripping of breaker Cᵢ depends on the position of said area of occurrence of fault D in feeder 1.

First protection relay Pᵢ is configured to calculate a complex value Zᵢ having a real part Re(Zᵢ) and an imaginary part Im(Zᵢ), to determine the feeder area comprising a single-phase permanent fault D. Complex value Zᵢ is calculated by a calculation system comprised within first protection relay Pᵢ, based on the phase voltage and phase current measured by the measurement circuit of search module Mᵢ.

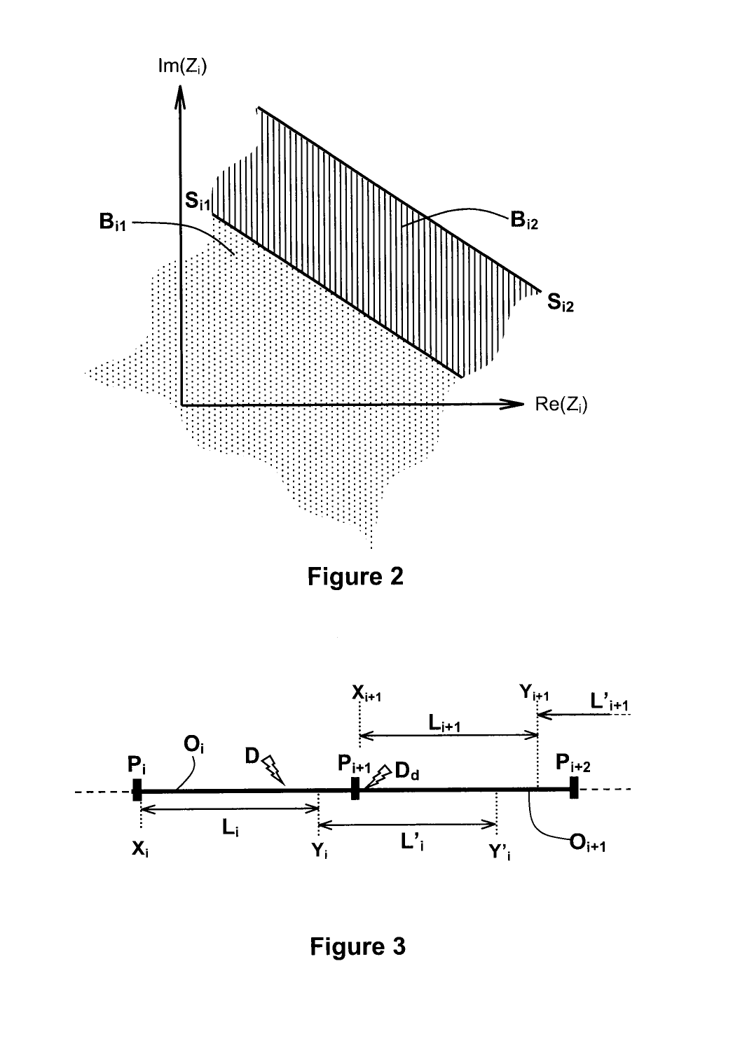

First protection relay Pᵢ also comprises a circuit for comparing calculated complex quantity Zᵢ with first and second complex thresholds Sᵢ₁ and Sᵢ₂. As illustrated in FIGS. 2 and 3, first and second complex thresholds Sᵢ₁ and Sᵢ₂ for example respectively correspond to first and second straight lines in a complex plane associated with orthonormal reference frame (O, Re(Zᵢ), Im(Zᵢ)). First complex threshold Sₒ defines in the complex plane a first domain Bᵢ₁ configured to represent the occurrence of a single-phase permanent fault D in a monitoring area Lᵢ associated with first protection relay Pᵢ and comprised in first element Oᵢ. First protection relay Pᵢ forms upstream end Xᵢ of monitoring area Lᵢ (and of first element Oᵢ). The first and second thresholds Sᵢ₁ and Sᵢ₂ also define in the complex plane a second domain Bᵢ₂, configured to represent the occurrence of a single-phase permanent fault D in an additional monitoring area L′ᵢ distinct from monitoring area Lᵢ and arranged downstream thereof.

Advantageously, in order for first protection relay Pᵢ to be able to monitor all the parts of element Oᵢ, additional area L′, is defined in first and second elements Oᵢ, and Oᵢ₊₁ so that downstream end Yᵢ of area Lᵢ, arranged in first element Oᵢ forms the upstream end of additional area L′ᵢ. First and second domains Bᵢ₁ and Bᵢ₂ are domains of the complex plane where the values of calculated quantity Zᵢ are plotted. First and second complex thresholds Sᵢ₁ and Sᵢ₂ are determined so that said first and second domains are distinct and do not overlap, at least in the portion of the complex plane where the values of calculated quantity Zᵢ are plotted.

First and second thresholds Sᵢ₁, and Sᵢ₂ associated with first protection relay Pᵢ are previously determined according to the configuration of the network. The configuration of a network depends on several parameters, including:
the nature (capacitive, resistive, inductive) and the value of the grounding impedance;
the type of operation of the network, that is, whether or not the network is powered or not by another back-up network;
the state of the breakers of the protection relays deployed in the feeder (normally opened/normally closed);
the existence of dispersed generation devices (DG) connected to the network;
the specifications of the equipment used in the network.

The mathematical formula of complex quantity Zᵢ takes into account at least the position of the location of occurrence of single-phase permanent fault D, with respect to the measurement circuit and the value of the resistance of this fault. Due to electromagnetic transient simulation means, it is possible to calculate different values of complex quantity Zᵢ according to the variation of the location of occurrence of a simulated single-phase permanent fault and to the variations of its resistance and according to the variation of its. Electromagnetic transient simulation means a simulation enabling to model the system with differential equations, and to follow the time variation of different electric quantities due to the occurrence of single-phase permanent faults in the system.

Preferably, the mathematical formula of complex quantity Zᵢ is selected so that the variation of real and imaginary parts Re(Zᵢ) and Im(Zᵢ) according to the location of occurrence of a single-phase permanent fault having a fixed resistance is a monotonous variation. Similarly, the variation of real and imaginary parts Re(Zᵢ) and Im(Zᵢ) of complex quantity Zᵢ according to the resistance of a fault appearing in a fixed location of feeder 1 is preferably selected to be monotonous. The location of occurrence of the single-phase permanent fault substantially corresponds to the distance existing between the single-phase permanent fault and the measurement circuit of the search module, weighted by the nature of the conductors separating the measurement circuit from the single-phase permanent fault.

The values of complex quantity Zᵢ calculated by simulation, for single-phase permanent faults having defined characteristics, may be represented in complex reference frame (O, Re(Zᵢ), Im(Zᵢ)). “Characteristic of a single-phase permanent fault” mainly designates its location of occurrence x and its resistance R_{def}.

The representation of the simulated values of complex quantity Zᵢ, for first protection relay Pᵢ, enables to delimit first domain Bᵢ₁ and second domain Bᵢ₂ of the complex plane. First domain Bᵢ₁ comprises most of the simulated values of quantity Zᵢ corresponding to a simulated fault having its location of occurrence belonging to a section of feeder 1 associated with monitoring area Lᵢ, and second domain Bᵢ₂ comprises most of the simulated values of quantity Zᵢ corresponding to a simulated fault having its location of occurrence belonging to a section of feeder 1 associated with additional monitoring area L′ᵢ. More generally, the simulated values enable to define an equation representing the occurrence of a single-phase permanent fault at the border of monitoring area Lᵢ with additional monitoring area L′ᵢ. Such an equation is representative of first threshold Sᵢ₁ in the complex plane.

After the determination of complex thresholds Sᵢ₁ and Sᵢ₂, the latter are used by the comparison circuit of first protection relay Pᵢ so that they can be compared with the values of complex quantity Zᵢ calculated from the measured phase voltage and current. The method of discrimination with complex thresholds advantageously enables to use the imaginary part and the real part of complex quantity Z for a better discrimination of the area comprising single-phase permanent fault D along feeder 1. Thresholds Sᵢ₁, and Sᵢ₂ associated with first protection relay Pᵢ advantageously correspond to straight lines in complex reference frame (O, Re(Zᵢ), Im(Zᵢ)) associated with the complex values of calculated quantity Zᵢ. A threshold in the form of a straight line defines two half-planes in this complex plane, and a straight line can be represented by a linear equation, which eases the calculation. Thus, the comparison of a value of complex quantity Zᵢ calculated by first protection relay Pᵢ with a threshold in the form of a straight line is easily implementable by using the linear equations representative of the thresholds.

Thereby, when a single-phase permanent fault D is detected downstream of first protection relay Pᵢ, the comparison circuit can determine whether fault D appears in monitoring area Lᵢ associated with first protection relay Pᵢ, or in additional monitoring area L′ᵢ. Based on this discrimination, search module Mᵢ controls breaker Cᵢ which is configured to cut out the electrical power distribution after a first time delay Tᵢ₁ when calculated quantity Zᵢ belongs to first domain Bᵢ₁ of the complex plane, in other words, fault D appears in a portion of feeder 1 associated with monitoring area Lᵢ. Breaker Cᵢ is also configured to cut out the electrical power distribution after a second time delay Tᵢ₂ longer than first time delay Tᵢ₁ when calculated quantity Zᵢ belongs to second domain Bᵢ₂ of the complex plane and when single-phase permanent fault D is still detected after first time delay Tᵢ₁.

First time delay Tᵢ₁ is determined according to the constraints of the network to be protected. Generally, first time delay Tᵢ₁ corresponds to the response time of a usual protection relay. The response time of a protection relay comprises a phase current and/or phase voltage measurement time, a time of processing and analysis of the data obtained from the measurements, and a response time of breaker Cᵢ. The response time of a protection relay may also comprise a time delay forming a security margin. Preferably, first time delay Tᵢ₁ is on the order of 200 ms. As an example, when a customer is directly connected to first element Oᵢ; to be protected by first protection relay Pᵢ, first time delay Tᵢ₁ advantageously comprises an additional time delay taking the customer protection relay into account. In this case, first protection relay Pᵢ will only trip after having left a sufficient time for the response of the customer protection relay, if the fault appears at the customer's premises. If the customer protection relay has not tripped after the additional time delay, first protection relay Pᵢ will take over and interrupt the power distribution. As an example, the first time delay may be on the order of 500 ms, which corresponds to the time delay for the customer protection relay to trip (typically 200 ms) plus a selectivity time delay (typically 300 ms).

Advantageously, the electrical power distribution network comprises a third protection relay Pᵢ₊₂ arranged between second protection relay Pᵢ₊₁ and the downstream end of feeder 1. Second and third protection relays Pᵢ₊₁ and Pᵢ₊₂ are arranged in feeder 1 to respectively define the upstream and downstream ends of a second element Oᵢ₊₁, associated with second protection relay Pᵢ₊₁. Additional monitoring area L′ᵢ is continuous and comprises a portion [Xᵢ₊₁, Yᵢ′] of second element Oᵢ₊₁. Downstream end Yᵢ, of monitoring area Lᵢ may be confounded with position Xᵢ₊₁ of second protection relay Pᵢ₊₁ in feeder 1. In this case, monitoring area Lᵢ is associated with element Oᵢ, as a whole. The fact of arranging several protection relays in series in feeder 1, and of defining at least two monitoring areas associated with each protection relay, advantageously enables to better discriminate a limited area of feeder 1 comprising fault D.

When a single-phase permanent fault D appears in section [Xᵢ, Yᵢ] of first element Oᵢ search module Mᵢ of first protection relay Pᵢ detects this fault in monitoring area Lᵢ associated with first protection relay Pᵢ. Thus, first protection relay Pᵢ rapidly interrupts, after a first time delay Tᵢ₁, the electrical power distribution downstream of first protection relay Pᵢ to protect the system, as well as the electric appliances of the customers connected to the system.

When a single-phase permanent fault D appears in portion [Xᵢ₊₁, Yᵢ′] of second element Oᵢ₊₁, it is detected by first and second protection relays Pᵢ and Pᵢ₊₁. Therefore, search module Mᵢ of first protection relay Pᵢ discriminates fault D in additional monitoring area L′ᵢ. First protection relay Pᵢ may act as a back-up protection relay for second protection relay Pᵢ₊₁. In this case, the first protection relay only interrupts the electrical power distribution if fault D is still detected after first time delay Tᵢ₁. The electrical power distribution is then interrupted by breaker Cᵢ of first protection relay Pᵢ after second time delay Tᵢ₂ longer than first time delay Tᵢ₁. In other words, first protection relay Pᵢ represents the back up of second protection relay Pᵢ₊₁ in the case of a failure of the operation thereof. Further, when a single-phase fault D appears in portion [Yᵢ, Xᵢ₊₁] located towards the end of first element Oᵢ, search module Mᵢ of first protection relay Pᵢ discriminates fault D in additional monitoring area L′ᵢ. The electrical power distribution is then interrupted by breaker Cᵢ of first protection relay Pᵢ after second time delay Tᵢ₂.

First and second time delays Tᵢ₁ and Tᵢ₂ are configured so that first and second protection relays Pᵢ and Pᵢ₊₁ operate according to a chronometric selectivity when they detect a single-phase permanent fault in portion [Xᵢ₊₁, Yᵢ′] of second element Oᵢ₊₁ to be protected by second protection relay Pᵢ₊₁. Difference Δt between first and second time delays Tᵢ₁ and Tᵢ₂ (Δt=Tᵢ₂−Tᵢ₁) forms a response time delay between first and second protection relays Pᵢ and Pᵢ₊₁, and it depends on the performance of the equipment used.

Preferably, each protection relay deployed in feeder 1 operates similar to first protection relay Pᵢ, to form a protection relay system using a time-space selectivity. Thus, for each protection relay, a monitoring area and an additional monitoring area are defined to monitor the element associated with said protection relay. As illustrated in FIG. 3 and as an example, a monitoring area Lᵢ₊₁ and an additional monitoring area Lᵢ₊₁′ are associated with second protection relay Pᵢ₊₁ and with second element Oᵢ₊₁. Advantageously, the protection relays are identical and they have the same time delays (Tᵢ₁=T₁ and Tᵢ₂=T₂). The protection relays deployed in feeder 1 may also have different time delays. In such conditions, the time delays associated with each protection relay deployed in feeder 1 are configured to provide a chronometric selectivity between each couple of consecutive protection relays of feeder 1. Such a configuration of the deployed protection relays provides a responsive and reliable protection relay system of feeder 1, without the need for fast communications between protection relays.

Monitoring area Lᵢ typically represents from 70% to 90% of the impedance of first element Oᵢ. In other words, the impedance corresponding to portion [Xᵢ, Yᵢ] represents from 70% to 90% of the value of the total impedance of first element Oᵢ. Similarly, additional area L′ᵢ monitors from 40% to 80% “by impedance” of second element Oᵢ₊₁ (corresponding to portion [Xᵢ₊₁, Yᵢ′]).

Such an arrangement of monitoring areas Lᵢ and L′ᵢ associated with first protection relay Pᵢ, advantageously enables to decrease the probability of a double tripping of first and second protection relays Pᵢ and Pᵢ₊₁. Double tripping is an instantaneous tripping of two protection relays of feeder 1 on detection of a same single-phase permanent fault D. A double tripping may be caused by calculation or discrimination errors.

Advantageously, additional monitoring area L′ᵢ associated with first protection relay Pᵢ is distinct from monitoring area L′ᵢ₊₁ associated with second protection relay Pᵢ₊₁. Indeed, a single-phase permanent fault appearing in second element Oᵢ₊₁ at the intersection between these two monitoring areas (L′ᵢ, L′ᵢ₊₁) may also cause a double tripping of first and second protection relays Pᵢ and Pᵢ₊₁ after second time delay T₂.

Poorly discriminated faults which cause double tripping generally appear at the beginning of an element Oⱼ associated with a protection relay Pⱼ of rank j. As an example, when a single-phase permanent fault D_{d} appears in second element Oᵢ₊₁ in the vicinity of second protection relay Pᵢ₊₁, in other words in the vicinity of position Xᵢ₊₁, it may cause a double tripping of first and second protection relays Pᵢ and Pᵢ₊₁ after first time delay T₁. Indeed, in the case where monitoring area Lᵢ is associated with the entire first element Oᵢ in other words, segment [Xᵢ, Xᵢ₊₁] of feeder 1, search module Mᵢ of first protection relay Pᵢ may erroneously discriminate fault D_{d} in monitoring area Lᵢ associated with first protection relay Pᵢ. Thus, first protection relay Pᵢ will trigger its breaker Cᵢ after first time delay T₁. Fault D_{d} is also detected by second protection relay Pᵢ₊₁ and will be discriminated in monitoring area Lᵢ₊₁ associated with second protection relay Pᵢ₊₁. Therefore, second protection relay Pᵢ₊₁ will trigger its breaker Cᵢ₊₁ after first time delay T₁ thus causing a double tripping.

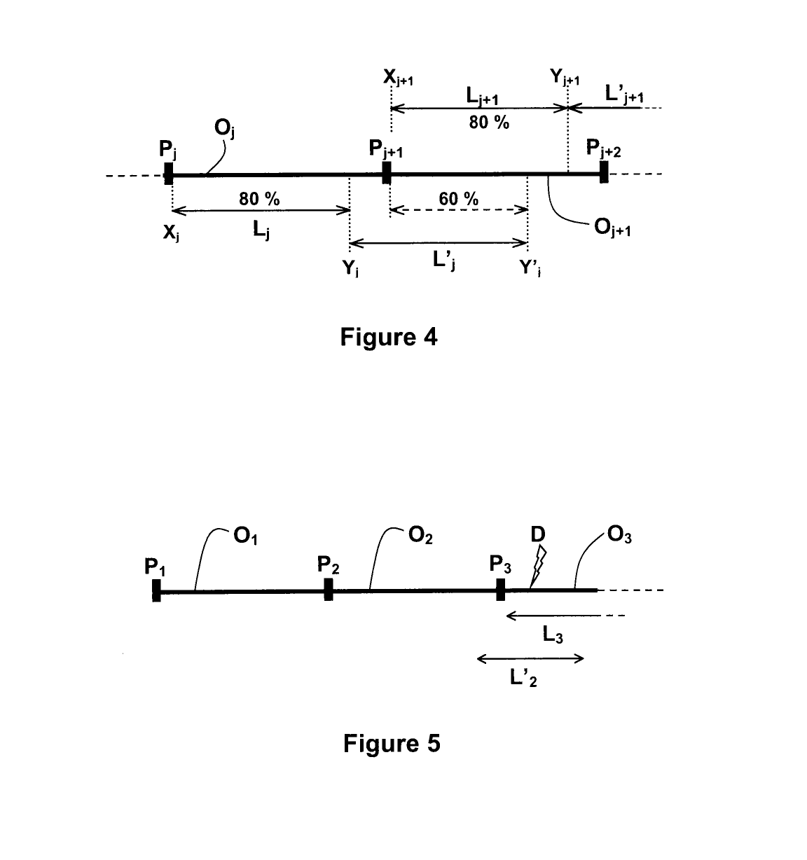

Advantageously, monitoring areas Lⱼ and L′ⱼ associated with protection relays Pⱼ of ranks j, j being an integer ranging between 1 and n−1, are defined to avoid double tripping or at least decrease their number in the protection relay system. The definition of monitoring areas Lⱼ and L′ⱼ is performed by adjustment of thresholds Sⱼ₁ and Sⱼ₂. As illustrated in FIG. 4, for each protection relay Pⱼ a monitoring area Lⱼ representing 80% by impedance of element Oⱼ, associated with said protection relay Pⱼ of rank j is preferentially defined. An additional monitoring area L′ⱼ is also defined to monitor the remaining 20% of element Oⱼ associated with protection relay Pⱼ of ranks j and 60% of element Oⱼ₊₁ associated with protection relay Pⱼ₊₁ of rank j+1.

To increase the security level for the tripping of the protection relays in a feeder 1 comprising at least three protection relays, protection relay P₁ of rank 1 advantageously provides a second security level for all protection relays arranged downstream thereof. In other words, for a feeder 1 comprising at least three protection relays, search module Mᵢ of protection relay P₁ of rank 1 triggers breaker C₁ associated with protection relay P₁ after a time delay T₁₃ longer than the time delays associated with the different protection relays of feeder 1. Such a tripping delayed by T₁₃ is performed when said search module M₁ of protection relay P₁ of rank 1 further detects single-phase fault D in feeder 1 even after the elapsing of the maximum time delay of the protection relays deployed downstream of protection relay P₁ of rank 1.

As illustrated in FIG. 5, on occurrence of a single-phase permanent fault D in element O₃ associated with the protection relay of rank 3 P₃, all the protection relays located upstream of this element simultaneously detect this fault. Search modules and breakers of rank 1 (C₁, M₁), 2 (C₂, M₂), and 3 (M₃, M₃), designate the search modules and the breakers respectively associated with protection relay P₁ of rank 1, with protection relay P₂ of rank 2, and with protection relay P₃ of rank 3.

As an example, it is considered that fault D appears in a portion of element O₃ covered with additional monitoring area L′₂ associated with rank-2 protection relay P₂ and area L₃ associated with rank-3 protection relay P₃. Rank-3 search module M₃, by discriminating the single-phase permanent fault in monitoring area L₃, will give to rank-3 breaker C₃ the order of tripping after first time delay T₁. Rank-2 search module M₂, by discriminating the single-phase permanent fault in additional monitoring area L′₂, will give to rank-2 breaker C₂ the order of tripping after a second time delay T₂ (T₂>T₁) if the single-phase permanent fault is still detected by rank-2 search module M₂ after first time delay T₁ has elapsed. In this example, it will be considered that the protection relays have the same first and second time delays T₁ and T₂.

Single-phase permanent fault D appearing in element O₃, rank-1 search module of M₁ can discriminate it neither in monitoring area L₁ associated with rank-1 protection relay P₁, nor in additional monitoring area L′₁. Further, by detecting the single-phase fault, first module M₁ will give rank-1 breaker C₁ the order of tripping after a third time delay T₃ (T₃>T₂) if the single-phase fault is still detected by search module M₁ of rank 1 after second time delay T₂ has elapsed.

The protection relays of ranks 1, 2, and 3 (P₁, P₂, P₃) thus operate according to a chronometric selectivity so that, ideally, rank-3 breaker C₃ trips after first time delay T₁. In case of a problem for tripping or discriminating rank-3 protection relay P₃, rank-2 protection relay P₂ acts as a back-up protection relay by tripping breaker C₂ after second time delay T₂. Rank-1 protection relay P₁ acts as an ultimate back-up protection relay, for all protection relays of feeder 1, by tripping its breaker Cₗ after a time delay T₃ if protection relays of ranks 2 and 3 P₂ and P₃ have had detection or discrimination problems.

Thereby, the configuration of the different protection relays deployed in feeder 1 enables to decrease the probability of tripping failure and of double tripping of the different protection relays, especially when a single-phase permanent fault appears in an element associated with a protection relay located downstream of rank-2 protection relay P₂.

The efficiency of operation of first protection relay Pᵢ, and thereby of the network protection relay system, strongly depends on the accuracy of the determination of the region of feeder 1 comprising a single-phase permanent fault D. Thus, the configuration of the protection relays by using a calculated complex value compared with complex thresholds advantageously provides a protection relay system operating according to a time-space selectivity which is accurate, responsive, and reliable. Further, the operation of the protection relay system according to a time-space selectivity is achieved without the need for fast communications between protection relays. Such a configuration also enables to form a more efficient and responsive protection relay system for heterogeneous networks and, by a certain extent, even for heterogeneous networks comprising DG devices.

Further, single-phase faults amount to from 70% to 80% of permanent faults which appear in medium-voltage distribution networks. Thereby, the above-described protection relay system eases the fast isolation of the area comprising this type of fault, and enables to limit the number of customers bothered on removal of the single-phase fault.

The formula of calculated quantity Zᵢ is preferably selected to be more sensitive to the variation of the location of the single-phase permanent fault than to the resistance thereof. Advantageously, quantity Zi calculated by processing and control module Mᵢ of first protection relay Pᵢ deployed in feeder 1 is provided by relation:

$${Z}_{i} = \frac{{V}_{i Φ}}{{I}_{i Φ} + {k}_{i} \cdot {I}_{iR}} with {I}_{iR} = {I}_{iA} + {I}_{iB} + {I}_{iC} \qquad ( 1 )$$

with:
Φ designating the faulted phase, A, B, or C, of the three-phase system;
i designating an index relative to first protection relay Pᵢ and corresponding to rank i of the protection relay deployed in feeder 1 according to the notation defined hereabove;
V_{iΦ} and I_{iΦ} representing the voltage and the current of faulted phase Φ measured by the measurement circuit of first protection relay Pᵢ in the presence of single-phase permanent fault D;
I_{iR} representing the residual current which is equal to the sum of the three phase currents (A, B, and C) measured by the measurement circuit of first protection relay Pᵢ and;
Kᵢ representing a calculation coefficient associated with first protection relay Pᵢ.

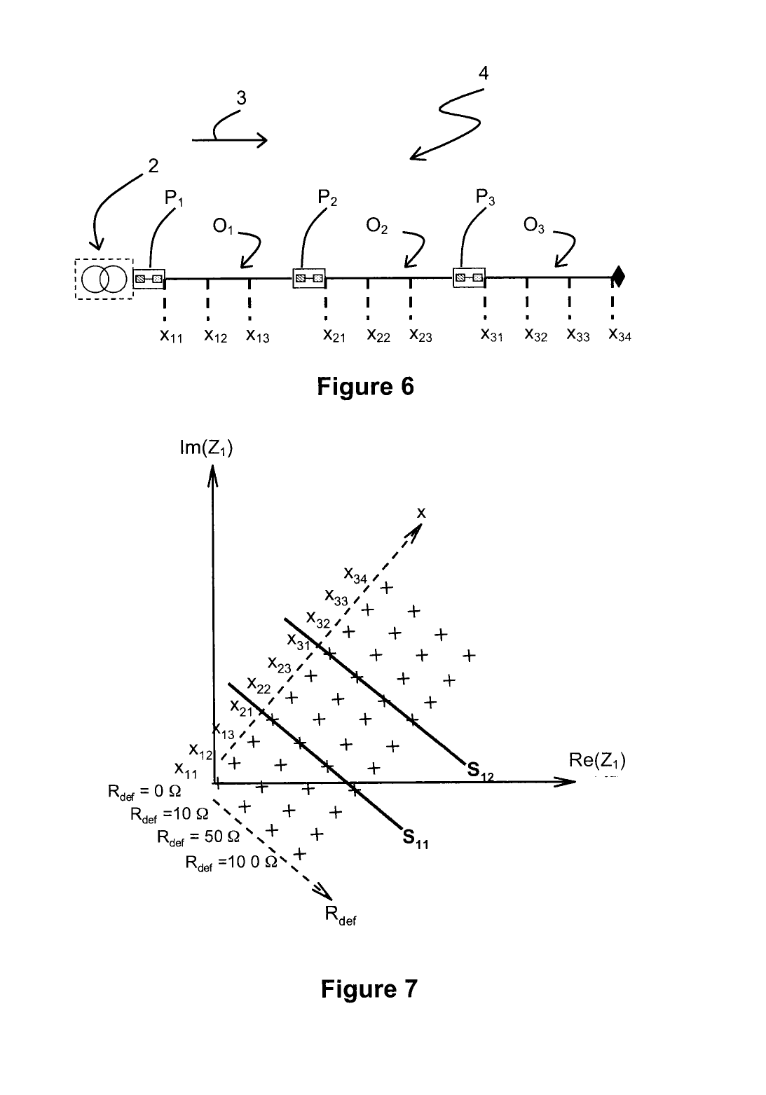

FIG. 6 illustrates an example of a theoretical network 4 for study purposes, for which the values of complex quantity Z₁ associated with first protection relay P₁ have been calculated by simulation. Theoretical study network 4 corresponds to a simple case, with an easy-to-verify consistency. Network 4 comprises three protection relays P₁, P₂, and P₃. Monitoring area L₁ represents the entire element O₁ associated with rank-1 protection relay P₁, and additional monitoring area L′₁ represents the entire element O₂ associated with the protection relay of rank 2. Areas L₁ and L′₁ each comprise three locations (x=x₁₁, x₁₂, x₁₃, and x=x₂₁, x₂₂, x₂₃) selected to simulate the occurrence of a single-phase permanent fault. Element O₃ has a last monitoring area L₃ associated with last protection relay P₃ of rank 3, and comprises four locations (x=x₃₁, x₃₂, x₃₃, x₃₄) selected to simulate the occurrence of a single-phase permanent fault. Between two consecutive locations x, direct line impedance Zₓ¹ is constant, that is, the fault simulation areas have equally distributed impedance. Thus, protection relays P₁, P₂, and P₃ also have equally distributed impedance. The electromagnetic transient simulations of faults in a network have been performed with software EMTP-ATP distributed by NTNU/SINTEF. The results of the phase voltages and currents obtained by the EMTP-ATP software have then been processed with commercial software MATLAB®.

As illustrated in FIG. 7, the coordinates of the values of complex quantity Z₁ calculated by simulation for first protection relay P₁, have been schematically shown in complex reference frame (O, Re(Z₁), Im(Z₁)). FIG. 7 advantageously shows the usefulness of the threshold lines to improve the discrimination of the regions of occurrence of faults in the network. Further, the discrimination is obtained by taking into account the variation of the real and imaginary parts of calculated quantity Z₁ according to location x and to resistance R_{def} of a single-phase permanent fault D.

In the case of FIG. 7, thresholds S₁₁ and S₁₂ are parallel straight lines formed by the values of quantity Z₁ respectively associated with the locations of faults x₂₁ and x₃₁. Indeed, thresholds S₁₁ and S₁₂ associated with first protection relay P₁ enable to define a first domain B₁₁ and a second domain B₁₂. The first domain, associated with faults detected by protection relay P₁ and appearing in monitoring area L₁, is defined by the half-plane delimited by threshold line S₁₁ and which comprises origin O of said reference frame. In the example of theoretical study network 4, it will be considered that additional monitoring area L′₁ associated with protection relay P₁ is formed by the area of feeder 1 arranged between protection relays P₂ and P₃. Second domain B₁₂, associated with single-phase faults detected by protection relay P₁ and appearing in additional monitoring area L′₁, is defined by the portion of the complex plane delimited by threshold lines S₁₁ and S₁₂. In the case of theoretical study network 4, first protection relay P₁ may be configured by using the linear equations corresponding to threshold lines S₁₁ and S₁₂.

FIG. 7 schematically shows a simple and ideal theoretical case where threshold lines S₁₁ and S₁₂ allow a perfect discrimination of the area comprising a fault detected by first protection relay P₁. However, in practice, the protection relays are not positioned in a feeder 1 so as to have an equally distributed impedance. In other words, the monitoring areas, delimited by the protection relays deployed in feeder 1, are generally heterogeneous. Thereby, the representation of the values of the calculated quantity in a complex reference frame may be different from that illustrated in FIG. 7.

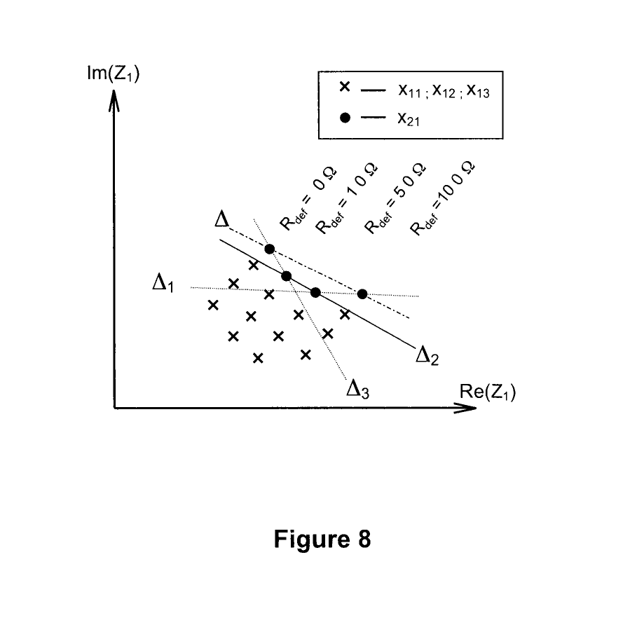

FIG. 8 illustrates a theoretical example of a distribution of values, obtained by simulation, of calculated quantity Z₁ in the complex reference frame. The fault positions are staggered in the same way as in the example shown in FIG. 6. The values associated with first fault position x₂₁ of the area associated with second protection relay P₂ are not linear. In the example of FIG. 8 where 4 values of the resistance of a single-phase permanent fault (R_{def}=0Ω, 10Ω, 50Ω, and 100Ω) are simulated, six eligible straight lines (combination of two points out of 4: C₄²=6) may be formed by the points corresponding to the values of complex quantity Z₁ simulated for fault position x₂₁. If the simulation has been performed for m fault resistance values, there will be Cₘ² eligible straight lines. The selection of the threshold line from among all eligible straight lines is advantageously based on two main criteria.

A threshold line of a given protection relay Pⱼ should not discriminate a fault in monitoring area Lⱼ while the fault appears in a portion of the feeder associated with additional monitoring area L′ⱼ. Such a condition forms a first criterion for the selection of the threshold line. As an example, straight line Δ shown in FIG. 8 does not satisfy this first criterion. Indeed, straight line Δ defines a first domain B₁₁ of the complex plane (associated with monitoring area L₁) comprising two points ((x, R_{def})=(x₂₁, 10Ω); (x₂₁, 50Ω)) which correspond to two single-phase faults appearing in a portion of the feeder associated with additional monitoring area L′₁. As illustrated in FIG. 8, among the six eligible straight lines, only three straight lines (Δₗ, Δ₂, Δ₃) satisfy this first criterion.

A threshold line preferentially leads to the highest discrimination probability (α_{Si-Pi}=n_{d}/n_{T}). This condition is a second criterion for the selection of the threshold line. Discrimination probability means the ratio between number n_{d} of values of complex quantity Zᵢ obtained by simulation, successfully discriminated by the determined threshold line (or threshold lines) Sᵢ of protection relay Pᵢ, and total number n_{T} of the values corresponding to the different simulated faults in locations belonging to a portion of the feeder associated with monitoring area Lᵢ (or L′ᵢ) of first protection relay Pᵢ. For the case of FIG. 8, the number of simulations performed for faults having their position belonging to a portion of the feeder associated with monitoring area L₁ is equal to 12 (n_{T}(L₁)=12). The probabilities for a successful discrimination associated with threshold lines Δ₁, Δ₂, and Δ₃ are respectively equal to α_{Δ1,P1}=10/12, α_{Δ2,P1}=12/12, and α_{Δ3,P1}=10/12. In the theoretical example of FIG. 8, straight line Δ₂ satisfies the first and second criteria. Thus, straight line Δ₂ may be selected as the first threshold line S₁₁ associated with first protection relay P₁ from among the six other eligible straight lines. The linear equation associated with threshold line Δ₂ is then introduced into search module M₁. On occurrence of a single-phase permanent fault in feeder 1, module M₁ compares the value of calculated quantity Z₁ (from the measured phase voltage and current) with said linear equation of straight line Δ₂, that is, first threshold S₁₁, to verify whether single-phase permanent fault D appears in a portion of the feeder associated with monitoring area L₁.

Having data relative to the probability of occurrence of single-phase permanent faults according to their resistances (which data may be provided by electrical power distributors), the discrimination probability α_{Si-Pi} is preferably weighted by the probability of occurrence of faults according to their resistances. Such a weighting of the probability advantageously enables to promote the discrimination of faults having the highest probability of occurrence, taking their resistances into account.

According to a specific embodiment of a method for protecting the above-described network, a first step of calculation of complex quantity Zᵢ is carried out on detection of a single-phase permanent fault by first protection relay Pᵢ. The calculation of complex quantity Zᵢ is performed from a phase voltage and current measured by the measurement circuit of search module Mᵢ of first protection relay Pᵢ. Calculated quantity Zᵢ is then compared with the first and second complex thresholds (Sᵢ₁, Sᵢ₂). The first and second thresholds (Sᵢ₁, Sᵢ₂) for example are linear equations which advantageously correspond to straight lines in the complex reference frame (O, Re(Zᵢ), Im(Zᵢ)) where the values of complex quantity Zᵢ can be represented. Preferably, calculated quantity Zᵢ is first compared with the straight line associated with first threshold Sᵢ₁. This first comparison enables to verify whether single-phase permanent fault D is located in monitoring area Lᵢ associated with first protection relay Pᵢ. If the first comparison does not enable to discriminate the single-phase fault in this area, then search module Mᵢ performs a second comparison of calculated quantity Zᵢ, with the straight line associated with second threshold Sᵢ₂ to verify whether single-phase permanent fault D is located in a portion of the feeder associated with additional monitoring area L′ᵢ.

The efficiency of the above-described protection relay method depends on the configuration of the first protection relay deployed in the network to be protected. “Configuration of a protection relay” means the pre-adjustment of the protection relay, before its tripping, intended to monitor a region of the network. The pre-adjustment essentially comprises a step where a protection relay is provided the complex thresholds and the time delays.

The formula of equation (1) shows that quantity Zᵢ calculated by search module Mᵢ of first protection relay Pᵢ, depends on calculation coefficient K. Thereby, the determination of the first and second thresholds (Sᵢ₁, Sᵢ₂) associated with first protection relay Pᵢ also depends on the selection of coefficient kᵢ. Advantageously, coefficient kᵢ is modulated to improve the efficiency of the discrimination by first protection relay Pᵢ of the monitored areas of feeder 1 comprising a single-phase permanent fault.

According to a specific embodiment of a method for adjusting first protection relay Pᵢ calculating complex value Zᵢ according to equation (1), coefficient kᵢ is modulated based on results of electromagnetic transient simulations. Indeed, the time variation of the phase current and voltage is studied on occurrence of a single-phase permanent fault D in feeder 1. The simulations are carried out to calculate the phase voltage and phase current in first protection relay Pᵢ by varying the place of occurrence x, in feeder 1, of single-phase permanent fault D and of its resistance R_{def}. Thereby, each performed simulation enables to calculate values of the phase voltage and current in first protection relay Pᵢ, for a single-phase permanent fault having a resistance R_{def} and appearing at a location x of feeder 1. Then, complex value Zᵢ is calculated for each performed simulation and for a given calculation coefficient K. The different calculated complex values Zᵢ(x, R_{def}) representative of the simulations and of a given calculation coefficient kᵢ, are then shown in complex reference frame (O, Re(Zᵢ), Im(Zᵢ)).

Calculation coefficient kᵢ is then modulated to vary the different calculated complex quantities representative of the simulations in complex reference frame (O, Re(Zᵢ), Im(Zᵢ)). The modulation comprises studying several values of calculation coefficient kᵢ. For each studied calculation coefficient K, first and second straight lines corresponding to the first and second thresholds (Sᵢ₁, Sᵢ₂) of first protection relay Pᵢ, are defined. The modulation of calculation coefficient kᵢ enables to define first and second threshold lines to delimit the maximum number of values of calculated quantity Zi corresponding to said first and second domains.

According to another specific implementation of the adjustment of first protection relay Pᵢ, the modulation of calculation coefficient kᵢ is advantageously performed by successive iterations by using the results of the electromagnetic transient simulations of single-phase permanent faults in feeder 1.

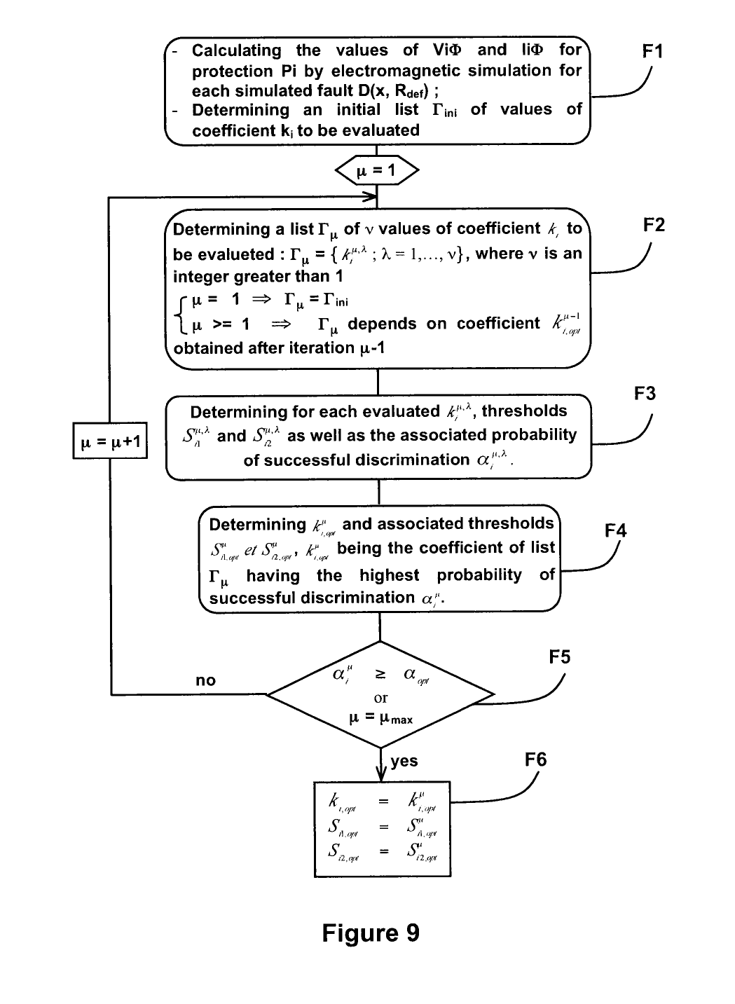

FIG. 9 illustrates steps F1 to F6 of a method for modulating calculation coefficient Kᵢ. At a first step F1, the values of the voltage and of the current of faulted phase V_{iΦ} and I_{iΦ} calculated by electromagnetic transient simulations for first protection relay Pᵢ and for single-phase permanent faults in feeder 1. The simulations are performed for several faults D(x, R_{def}) by varying, at least one of the following characteristics: location x of occurrence in feeder 1 and resistance R_{def} of fault D. Preferably, the variation of the occurrence location is imposed so as to scan first and second elements Oᵢ and Oᵢ₊₁ of feeder 1. During first step F1, an initial list Γᵢₙᵢ of ν values of coefficient kᵢ to be evaluated during the first iteration is determined. Number v of values of coefficient kᵢ to be evaluated, in other words, the size of list Γᵢₙᵢ, mainly depends on the power of the calculator which performs said evaluation.

The modulation of calculation coefficient kᵢ is performed so that for each iteration μ, μ being an integer ranging between 1 and μₘₐₓ a previously-determined maximum number of iterations, evaluation calculations are performed. Such evaluation calculations are carried out for each calculation coefficient kᵢ^{μ,λ} to be evaluated belonging to a list Γ_{μ}={kᵢ^{μ,λ} λ=1, 2, . . . ν}, number ν being an integer greater than or equal to 2 which may vary according to iteration μ. Step F2 of the diagram of FIG. 9 comprises determining list Γ_{μ} of the values of coefficient kᵢ to be evaluated during iteration μ. In other words, for each iteration μ, coefficient kᵢ successively takes the values of coefficients kᵢ^{μ,λ} of list Γ_{μ}. At the first iteration (μ=1), list Γ_{μ} is the previously-determined list Γᵢₙᵢ. From the second iteration (μ>=2), list Γ_{μ} of the values of complex coefficient kᵢ to be evaluated depends on a coefficient k_{i,opt}^{μ-1} obtained at the end of iteration μ−1 (after step F4).

Step F3 of the modulation method comprises determining for each evaluated calculation coefficient kᵢ^{μ,λ} first Sᵢ₁^{μ,λ} and second Sᵢ₂^{μ,λ} thresholds respectively associated with monitoring area Lᵢ, and with additional monitoring area L′ᵢ. The evaluation calculations exploit the results of previously-performed electromagnetic transient simulations of single-phase permanent faults. Thus, for each evaluated calculation coefficient kᵢ^{μ,λ}, a probability αᵢ^{μ,λ} of successful discrimination associated with the first Sᵢ₁^{μ,λ} and second Sᵢ₂^{μ,λ} thresholds is calculated. Probability αᵢ^{μ,λ} of successful discrimination depends on probabilities αᵢ₁^{μ,λ} and αᵢ₂^{μ,λ} which respectively correspond to the probability of successful discrimination associated with first threshold Sᵢ₁^{μ,λ} and with second threshold Sᵢ₂^{μ,λ}. Probabilities αᵢ₁^{μ,λ}, αᵢ₂^{μ,λ} and first and second thresholds Sᵢ₁^{μ,λ} and Sᵢ₂^{μ,λ} are determined similarly to what has been described for the theoretical case of FIGS. 6 to 8.

Advantageously, for the first iteration (μ=1), list Γᵢₙᵢ of values kᵢ^{1,λ} to be evaluated covers a wide range of variation of calculation coefficient kᵢ. Coefficient kᵢ being a complex coefficient, the real part of the coefficients to be evaluated at the first iteration may vary within an interval Aᵣ=[−aᵣ/2, aᵣ/2], and the imaginary part may vary within an interval Aᵢ=[−aᵢ/2, aᵢ/2], aᵣ and aᵢ being real numbers defining intervals Aᵣ and Aᵢ. Preferably, intervals Aᵣ and Aᵢ are identical (aᵣ=aᵢ) and are scanned with a step p₁. Thus, a total number of (E((aᵣ/p₁)+1)*E((aᵢ/p₁)+1)) coefficients kᵢ will be evaluated, where E(β) designates the integral part of a real number β. In other words, list Fᵢₙ; comprises ν values, ν being equal to E((aᵣ/p₁)+1)*E((aᵢ/p₁)+1). Number ν of the calculation coefficient values to be evaluated mainly depends on the power of the calculator which calculates the values of quantity Zi obtained by simulation and determines the thresholds and the calculation of the different probabilities.

Further, after each iteration μ, a coefficient k_{i,opt}^{μ} is selected from list Γ_{μ}. The selected coefficient, k_{i,opt}^{μ}, corresponds to the calculation coefficient kᵢ^{μ,λ} of list Γ_{μ} which has the highest discrimination probability αᵢ^{μ} (αᵢ^{μ}=max(αᵢ^{μ,λ})). The coefficient selected at iteration μ will be used to determine list Γ_{μ+1} of coefficients kᵢ^{μ+,λ} to be evaluated for iteration μ+1. In other words, for each iteration μ for μ varying between 2 and μₘₐₓ, list Γ_{μ} of the values of coefficients kᵢ^{μ,λ} to be evaluated depends on calculation coefficient k_{i,opt}^{μ-1} selected at the end of iteration μ−1. Indeed, for each iteration, the optimization searches for a calculation coefficient having the highest discrimination probability, more finely around the calculation coefficient selected at the end of the previous iteration.

During an iteration μ, coefficient kᵢ has been evaluated by taking, each time, a value from list Γ_{μ} corresponding to the values of a domain A_{μ}=[−a_{μ,r}/2, a_{μ,r}/2]×[−a_{μ,i}/2, a_{μ,i}/2] scanned with a step p_{μ}, where a_{μ,r} and a_{μ,i} are two real numbers. Intervals [−a_{μ,r}/2, a_{μ,r}/2] and [−a_{μ,i}/2, a_{μ,i}/2] respectively correspond to the variation ranges of the real part and of the imaginary part of values kᵢ^{μ,λ} to be evaluated during iteration μ. The variation range of coefficients kᵢ^{μ+1,λ} to be evaluated during iteration μ+1 is preferably centered on the real and imaginary parts of coefficient k_{i,opt}^{μ selected at the end of iteration μ. Preferably, the variation range of the coefficients to be evaluated during iteration μ+}1 corresponds to:

A_{μ+1}=A_{μ+1,r}×A_{μ+1,i}=[Re(k_{i,opt}^{μ})−a_{μ,r}/(2*b),Re(k_{i,opt}^{μ})+a_{μ,r}/(2*b)]×[Im(k_{i,opt}^{μ})−a_{μ,i}/(2*b),Im(k_{i,opt}^{μ})+a_{μ,r}/(2*b)]

b being a real number greater than 1.

Variation intervals A_{μ+1,r} and A_{μ+1,i} are thus smaller than intervals A_{μ,r} and A_{μ,i} associated with iteration μ. To keep the same number of values of the calculation coefficients evaluated after two successive iterations μ and μ+1, step p_{μ+1} with which range A_{μ+1} is scanned is preferably equal to the step of iteration μ divided by b (p_{μ+1}=p_{μ}/b).

During step F5 of the modulation method, the probabilities of successful discrimination αᵢ^{μ,λ} determined at iteration μ are compared with a previously-determined probability threshold αₒₚₜ. If probabilities αᵢ^{μ,λ} of successful discrimination are lower than this threshold and if the maximum number of iterations μₘₐₓ has not been reached (output no of F5), it is looped back onto step F2. If the highest discrimination probability αᵢ^{μ}, determined at iteration μ is greater than or equal to probability threshold αₒₚₜ, or if maximum number μₘₐₓ of iterations has been reached (output yes of F5), the modulation operation is stopped. Preferably, probability threshold αₒₚₜ is equal to 1. At the end of the modulation method, a modulated calculation coefficient k_{i,opt} which corresponds to the calculation coefficient k_{i,opt}^{μ} having the best probability of successful discrimination αᵢ^{μ}, which is selected once the last iteration μ has been performed, is thus obtained.

A protection relay system formed according to the embodiments or implementation modes described hereabove advantageously is a reliable and easy-to-implement system. The protection relay system is also adapted to heterogeneous networks comprising several conductors of different cross-section and nature (overhead line, underground cable . . . ) and dispersed energy generation devices (DG). The portability of the detection and discrimination method on urban or rural networks with or without distributed production (DG) has been successfully tested. The networks have been studied according to all types of neutral mode of medium-voltage distribution networks (high-impedance neutral, compensated neutral, isolated neutral, and directly-grounded neutral). The percentage of successful discrimination has been evaluated for different studied networks, and it ranges between 91 and 100% for a discrimination of a single-phase permanent fault and a tripping after a first time delay. The percentage is close to 100% when the discriminations and the trippings after a second time delay longer than the first time delay are taken into account.

1. Electrical power distribution network comprising:
a medium-voltage feeder having an upstream end and a downstream end, the upstream end being intended to be connected to a power source;
at least first and second consecutive protection relays positioned along said feeder and arranged so that the first protection relay is located between the upstream end of said feeder and the second protection relay, the first and the second protection relays defining the upstream and downstream ends of a first element associated with the first protection relay;
wherein the first protection relay comprises:
a search module configured to detect a single-phase permanent fault downstream of the first protection relay, the search module being provided with a phase current and phase voltage measurement circuit;
a computer configured for computing a complex quantity Zᵢ having a real part Re(Zᵢ) and an imaginary part Im(Zᵢ), from the measured phase voltage and phase current, said complex quantity Zᵢ taking into account the position of the location of the single-phase permanent fault with respect to said measurement circuit, and a resistance value of the fault;
a comparator configured for comparing the complex quantity Zᵢ with first and second complex thresholds corresponding to first and second straight lines in a complex plane associated with reference frame (O, Re(Zᵢ), Im(Zᵢ)) wherein:
the first complex threshold defining in the complex plane a first domain configured to represent occurrence of a single-phase permanent fault in a monitoring area comprised in the first element and having the first protection relay as an upstream end, and
the second threshold defining with the first threshold in the complex plane a second domain which does not overlap with the first domain, and which is configured to represent occurrence of a single-phase permanent fault in an additional monitoring area distinct from said monitoring area and arranged downstream thereof so that the downstream end of the monitoring area corresponds to the upstream end of the additional monitoring area;
a breaker for cutting out the electrical power distribution downstream of the first protection relay after:
a first time delay when the complex quantity Zᵢ belongs to the first domain of the complex plane;
a second time delay longer than the first time delay when the calculated complex quantity Zᵢ belongs to the second domain of the complex plane, and when the single-phase fault is still detected after the first time delay.

2. Electrical power distribution network according to claim 1, comprising a third protection relay arranged between the second protection relay and the downstream end of the feeder, the second and third protection relays defining the upstream and downstream ends of a second element associated with the second protection relay, the additional monitoring area is continuous and comprises a portion of the second element.

3. Electrical power distribution network according to claim 1 wherein the calculated complex quantity Z is provided by relation:
$${Z}_{i} = \frac{{V}_{i Φ}}{{I}_{i Φ} + {k}_{i} \cdot {I}_{iR}} with {I}_{iR} = {I}_{iA} + {I}_{iB} + {I}_{iC} \qquad ( 1 )$$
Φ designating the faulted phase, A, B, or C, of the three-phase system;
i designating an index relative to the first protection relay;
V_{iΦ} and I_{iΦ} representing the voltage and current of the faulted phase, measured by the measurement system of the first protection relay in the presence of the single-phase fault;
I_{iR} representing the residual current which is equal to the sum of the three phase currents measured by the measurement circuit of the first protection relay and;
kᵢ representing a calculation coefficient associated with the first protection relay.

4. Method for protecting an electrical power distribution network according to claim 1, comprising the following steps on detection of a single-phase permanent fault by the first protection relay:
a calculation of the complex quantity Zᵢ from a phase current and phase voltage measured by the measurement circuit;
a comparison of the calculated value Zᵢ with the first and second complex thresholds corresponding to straight lines in the complex reference frame (O, Re(Zᵢ), Im(Zᵢ));
a verification of the presence of a single-phase permanent fault either in the monitoring area, or in the additional monitoring area.

5. Method for adjusting the first protection relay of the power distribution network according to claim 3, comprising the steps of:
carrying out a plurality of electromagnetic transient simulations of the feeder on occurrence of a single-phase permanent fault to calculate the phase voltage and phase current in the first protection relay, the simulations being performed by varying at least the location of occurrence of the single-phase permanent fault and the resistance thereof;
calculating the complex quantity Zᵢ for each simulation;
representing the different calculated complex quantities representative of the simulations in the complex reference frame (O, Re(Zᵢ), Im(Zᵢ));
modulating calculation coefficient kᵢ to vary the different values of the calculated quantity Zᵢ in the complex reference frame (O, Re(Zᵢ), Im(Zᵢ)), and to achieve a definition of the first and second straight lines, corresponding to the first and second threshold, delimiting the maximum number of values of the calculated quantity Zᵢ corresponding to said first and second domains.

6. Method for adjusting a protection relay of a power distribution network according to claim 5, wherein the modulation of calculation coefficient kᵢ is performed so that:
for each iteration μ, μ being an integer ranging between 1 and μₘₐₓ a maximum number of iterations determined beforehand, evaluation calculations exploiting the results of the electromagnetic transient simulations of single-phase permanent faults in the feeder are carried out for each calculation coefficient kᵢ^{μ,λ} belonging to a list Γ_{μ} of ν coefficients Γ_{μ}={kᵢ^{μ,λ}, λ=1, . . . , ν} for each evaluated calculation coefficient kᵢ^{μ,λ}, first Sᵢ₁^{μ,λ} and second Sᵢ₂^{μ,λ} thresholds associated with the first protection relay are determined and a probability αᵢ^{μ,λ} of successful discrimination of the monitoring areas comprising the simulated fault is calculated;
after each iteration μ, a coefficient k_{i,opt}^{μ} is selected from list Γ_{μ}, the selected coefficient k_{i,opt}^{μ} having the highest discrimination probability αᵢ^{μ};
for each iteration μ, with μ varying between 2 and μₘₐₓ, list Γ_{μ} of the ν values of coefficients kᵢ^{μ,λ} to be evaluated depends on the selected calculation coefficient k_{i,opt}^{μ-1} obtained after iteration μ−1;
the optimization is stopped when the number of iterations reaches μₘₐₓ or when the highest discrimination probability αᵢ^{μ}, determined during iteration μ, is greater than or equal to a probability threshold αₒₚₜ determined beforehand;
the modulation calculation coefficient k_{i,opt} corresponds to coefficient k_{i,opt}^{μ} obtained during the last iteration to have been performed.
